(19) United States
(12) Patent Application Publication
(10) Pub. No.: US 2013/0185484 A1
(43) Pub. Date: Jul. 18, 2013

(54) FILE PROGRAMMING METHOD AND ASSOCIATED DEVICE FOR NAND FLASH

(71) Applicant: MStar Semiconductor, Inc, Hsinchu County (TW)

(72) Inventor: Tao Zhou, Shanghai (CN)

(73) Assignee: MSTAR SEMICONDUCTOR, INC., Hsinchu County (TW)

(21) Appl. No.: 13/742,524

(22) Filed: Jan. 16, 2013

(30) Foreign Application Priority Data
Jan. 17, 2012 (CN) 201210013811.6

(51) Int. Cl. G06F 12/02

(52) U.S. Cl. CPC G06F 12/0246
USPC 711/103

(57) ABSTRACT

A file programming method for a flash memory is provided. The method includes steps of: obtaining a section description file and corresponding allocation information and user data while generating burning files, wherein the section description file includes section description information of at least one section and the allocation information includes the number that the burning file is to be generated; determining a file type corresponding to a section file according to the section description information; and generating the burning files utilizing the user data according to section description information, the number that the burning file is to be generated corresponding to the section description information, and the file types corresponding to the section files.

This application claims the benefit of People's Republic of China application Serial No. 201210013811.6, filed Jan. 17, 2012, the disclosure of which is incorporated by reference herein in its entirety.

### BACKGROUND

1. Technical Field

The disclosed embodiments relate in general to a field of computer data storage, and more particularly to a file programming method and associated device for a NAND flash.

2. Description of the Related Art

A NAND flash features a large capacity, a fast access speed and a low cost per unit capacity, and thus prevails as a data carrier in the embedded computer flash memory field.

A NAND flash is mainly categorized into two file types—a Memory Technology Device (MTD) type and an Unsorted Block Images (UBI) type.

The UBI is open-source NAND flash management software capable of effectively enhancing reliability and a life cycle of the NAND flash. In the UBI type, UBI system data is added to a header of each set of user data. The user data is organized in an independent binary (bin) file in a form of divided sections. The size of the sections is aligned with the size of storage blocks, and descriptions of the divided sections are managed by a UBI volume table. As mentioned, in the UBI type, the UBI system data is added to the header of each user data block, and the UBI system data is logically adjacent to (directly accessible by) upper-layer applications. On the other hand, a file in the MTD type does not have its own management information, but includes only original data.

To optimize production efficiency during a mass production process, a dedicated programmer usually writes data to be burned into a NAND flash, and so dedicated burning files need to be provided for the programmer. Therefore, the quality and size of burning files directly affects efficiency and a yield rate of mass production.

In the prior art, an upgrade of a product is generally completed using a network, a serial port, or Universal Serial Bus (USB). From the upgraded product, all data in the NAND flash is read in order to accordingly generate a burning file. Although being quite direct and easily feasible, the conventional solution above suffers from drawbacks of having tediously complicated operational steps, exclusive relativity between contents of a burning file and a particular product, as well as being a very time-consuming process.

Therefore, there is a need for a solution to enhance this methodology for a simple, reliable, and flexible file burning approach.

### SUMMARY

The disclosure is directed to a file programming method and associated device for a NAND flash, so as to automatically generate a burning file according to different file types and enhance efficiency of file burning to a NAND flash.

According to an aspect of the disclosure, a file programming method for a NAND flash is provided. The method includes the steps of: obtaining a section description file and corresponding allocation information and user data when a burning file is to be generated for the NAND flash, wherein the section description file includes section description information of at least one section and the allocation information includes the number that the burning file is to be generated; determining a file type of a corresponding section file according to the section description information; and generating the burning file utilizing the user data according to the section description information, the number that the burning file is to be generated corresponding to the section description information, and the file type of the section file.

According to another aspect of the disclosure, a file programming device for a NAND flash is provided. The file burning device includes: a retrieving module, for obtaining a section description file and corresponding allocation information and user when a burning file is to be generated for the NAND flash, wherein the section description file includes section description information of at least one section and the allocation information includes the number that the burning file is to be generated; determining a file type of a corresponding section file according to the section description information; a first determining module, for determining a file type of a corresponding section file according to the section description file obtained by the retrieving module; and a file burning module, for generating the burning file according to section description information, the number that the burning file is to be generated corresponding to the section description information, and the file type of the section file.

With the file programming method and associated device of the disclosure, a file type is determined to automatically generate a burning file from different file types. Such an approach is simple, reliable, and flexible, and also increases burning efficiency.

### BRIEF DESCRIPTION OF THE DRAWINGS

FIG. 1 is a flowchart of a file programming method according to one embodiment of the disclosure.

FIG. 2 is a flowchart of generating an MTD burning file in a file programming method according to one embodiment of the disclosure.

FIG. 3 is a flowchart of generating a UBI burning file in a file programming method according to one embodiment of the disclosure.

FIG. 4 is a schematic diagram of user data and ECC codes stored in a NAND flash according to one embodiment.

FIGS. 5A and 5B are flowcharts of generating a mixed burning file in a file programming method according to one embodiment of the disclosure.

FIG. 6 is a schematic diagram of constituents of a mixed burning file generated in a file programming method according to one embodiment of the disclosure.

FIG. 7 is a block diagram of a file programming device according to one embodiment of the disclosure.

FIG. 8 is a block diagram of a file programming device according to another embodiment of the disclosure.

FIG. 9 is a block diagram of a file programming device according to another embodiment of the disclosure.

FIG. 10 is a block diagram of a file programming device according to yet another embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

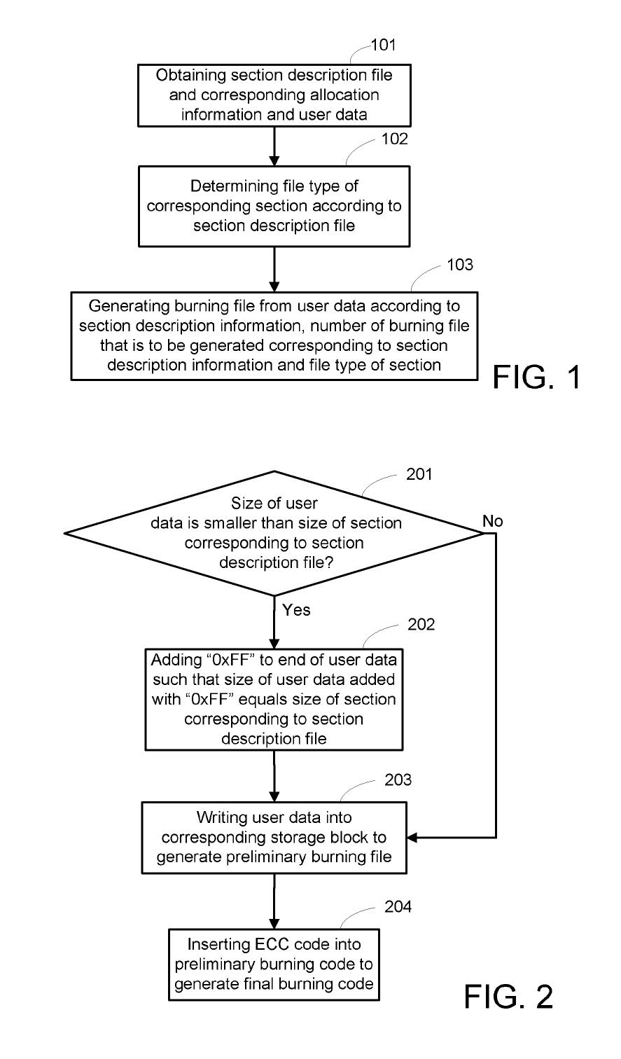

FIG. 1 shows a flowchart of a file programming method for a NAND flash according to one embodiment. The file programming method is described in detail with reference to FIG. 1.

In step 101, a section description file and corresponding allocation information and user data are obtained. That is, when a burning file is to be generated for a NAND flash, a section description file and corresponding allocation information and user data are obtained. The section description file includes section description information of one or multiple sections, the allocation information includes the number that the burning file is to be generated, and the user data is main data to be burned. For example, the section description file and the corresponding allocation information and user data may be stored in advance in a local end of the NAND flash, or inputted by a user.

In step 102, a file type of a corresponding section file is determined according to the section description file. The section description file includes the section description information of one or multiple sections, and the section description information may further include information such as the file type and the size of the sections.

In other words, after obtaining the section description file and the corresponding allocation information and user data in step 101, the file type of the corresponding section file is determined according to the obtained section description file.

In step 103, a burning file is generated from the user data according to the section description information, the number that the burning file is to be generated corresponding to the section description information, and the file type of the section file. As different file types have different storage formats, different approaches are adopted for generating the burning file with respect to files of different types. For example, the MTD type contains only original user data, whereas the UBI type further contains a UBI volume table and UBI system data. Therefore, for files of different types, different approaches are adopted for generating the burning file. The generated burning file is then written into the NAND flash.

Thus, by determining the file type, the burning file is generated from the user data with respect to different file types according to the section description file and the number that the burning file is to be generated. Such an approach is simple, reliable, and flexible, and also increases burning efficiency.

Taking the MTD type, the UBI type and a mixed type containing the MTD type and the UBI type as examples, the file programming process is described in detail below.

FIG. 2 shows a flowchart of generating an MTD burning file in a file programming method according to one embodiment. When it is determined that the file type of the section file corresponding to the section description file is an MTD type, details of generating a corresponding MTD burning file are as described below.

In step 201, it is determined whether the size of the user data is smaller than the size of the section corresponding to the section description file. That is, it is determined whether the size of the user data obtained in step 101 is smaller than the size of the section corresponding to the section description file. Step 202 is performed when the size of the user data is smaller than the size of the section corresponding to the section description file, or else step 203 is performed when the size of the user data is not smaller than the size of the section corresponding to the section description file.

In step 202, “0xFF” is added to an end of the user data. The size of the sections is aligned with the size of the storage blocks when originally configured. However, unaligned sizes may be incurred during the process of generating the burning file due to different-sized sections and storage blocks. Thus, when it is determined that the size of the user data is smaller than the size of the section corresponding to the section description file, “0xFF” is added to the end of the user data so that the size of the user data added with “0xFF” is equal to the size of the section corresponding to the section description file.

In step 203, the user data is written into a corresponding storage block to generate a preliminary burning file. When the size of the user data equals the size of the section corresponding to the section description file, the user data is written into the corresponding storage block to generate the preliminary burning file.

It should be noted that, the allocation information includes the number that the burning file is to be generated. That is, according to the number that the burning file is to be generated as instructed in the allocation information, one or multiple burning files may be generated. The number that the burning file is to be generated specified in the allocation information is designed according to actual requirements.

In step 204, an error checking and correcting (ECC) code is inserted into the preliminary burning file to generate a final burning file.

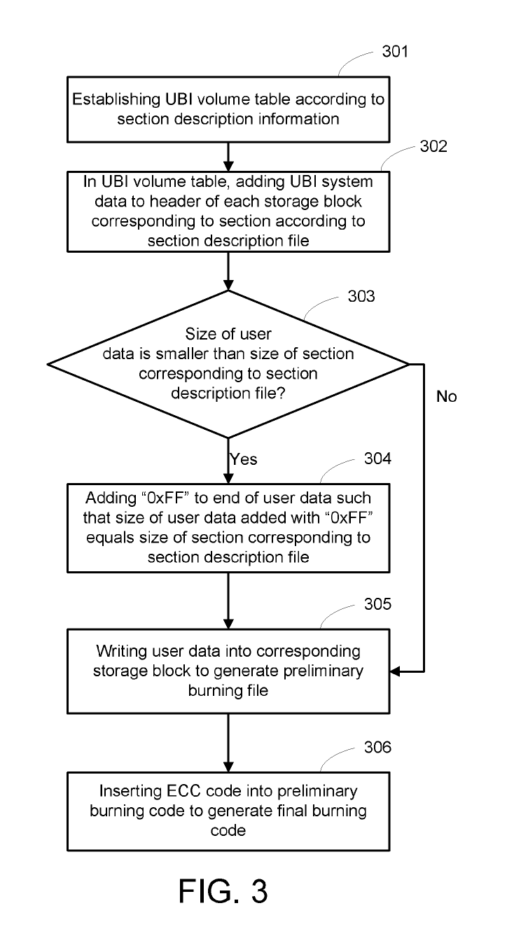

FIG. 3 shows a flowchart of generating a UBI burning file in a file programming method according to one embodiment. When it is determined that the file type of the section file corresponding to the section description file is a UBI type, details of generating a corresponding UBI burning file are as described below.

In step 301, a UBI volume table is established according to the section description information. That is, a UBI volume table is established according to the section description information in the section description file obtained in step 101. The UBI volume table is a volume table for managing section descriptions of the sections.

In step 302, in the UBI volume table, UBI system data is added to a header or each of the storage blocks corresponding to the section according to the section description file. The size of the sections is aligned with the size of the storage blocks. Each section may be aligned with one storage block or may be aligned with multiple storage blocks, depending on the sizes of the sections and the storages blocks. For example, assuming that the size of one section is 10240 KB and the size of one storage block is 1024 KB, the section is then aligned with 10 storage blocks.

After establishing the UBI volume table, the UBI system data is added to the header of each of the storage blocks corresponding to the section according to the section description file.

In step 303, it is determined whether the size of the user data is smaller than the size of the section corresponding to the section description file. That is, after step 302, it is then determined whether the size of the user data is smaller than the size of the section corresponding to the section description file. Step 304 is performed when a determination result is affirmative indicating that the size of the user data is smaller than the size of the section corresponding to the section description file, or else step 305 is performed when the determination result is negative indicating that the size of the user data is not smaller than the size of the section corresponding to the section description file.

In step 304, “0xFF” is added to the end of the user data. A purpose of this step is to ensure the alignment of the section and the storage block. The size of the sections is aligned with the size of the storage blocks when originally configured. However, unaligned sizes of the sections and the storage blocks may be incurred during the process of generating the burning file if the size of the user data is smaller than the size of the section.

Thus, when it is determined that the size of the user data is smaller than the size of the section corresponding to the section description file in step 303, “0xFF” is added to the end of the user data so that the size of the user data added with “0xFF” is equal to the size of the section corresponding to the section description file.

In step 305, the user data is written into a corresponding storage block to generate a preliminary burning file. When the size of the user data equals the size of the section corresponding to the section description file, the user data is written into the corresponding storage block to generate the preliminary burning file.

It should be noted that, the allocation information includes the number that the burning file is to be generated. That is, according to the number that the burning file is to be generated as instructed in the allocation information, one or multiple burning files may be generated. The number that the burning file is to be generated specified in the allocation information is designed according to actual requirements.

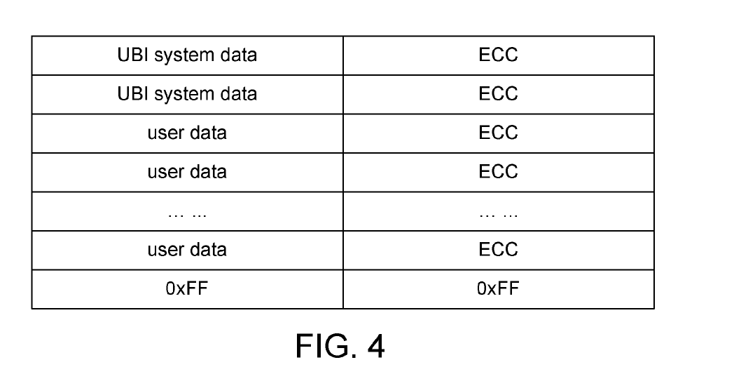

In step 306, an ECC code is inserted into the preliminary burning file to generate a final burning file. The user data, the UBI system data and the added “0xFF” are stored in a main area of the storage block, and the ECC code is stored in a spare area of the storage block, as shown in FIG. 4.

FIG. 4 shows a schematic diagram of user data and ECC codes stored in a NAND flash. A block of a NAND flash is divided into a number of pages, each of which is further divided into a main area and a spare area. The user data, the UBI system data and the added “0xFF” are stored in the main area of the storage block, and the ECC code is stored in the spare area of the storage block.

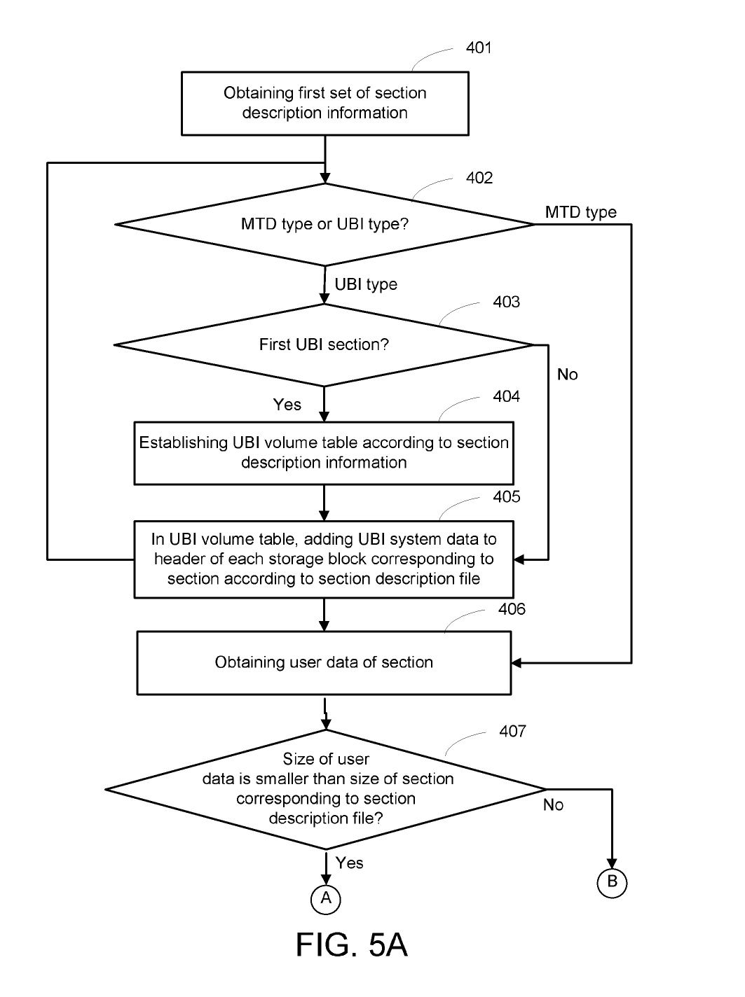

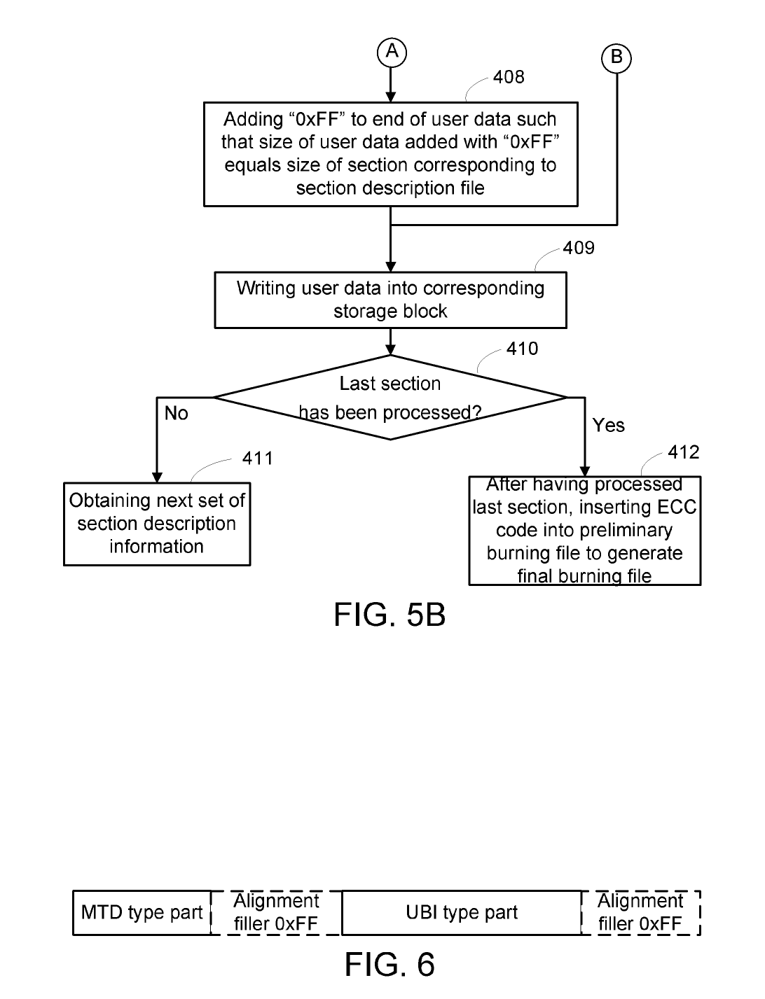

FIGS. 5A and 5B are flowcharts of generating a mixed burning file in a file programming method according to one embodiment. When it is determined that the file type of the section file corresponding to the section description file is a mixed type including MTD and UBI types, details of generating a corresponding mixed burning file are as described below.

In step 401, a first set of section description information is obtained. In step 402, it is determined whether the file type is an MTD type or a UBI type. Step 406 is performed when the file type is the MTD type, or else step 403 is performed when the file type of the UBI type.

In step 403, it is determined whether a section is a first UBI section. When it is determined that the section described by the section description information is a UBI section, it is further determined whether the obtained UBI section is the first UBI section.

In step 404, a UBI volume table is established according to the section description information. When the section described in the obtained section description information is the first UBI section, the UBI volume table is established according to the section description information in the section description file. The UBI volume table is a volume table for managing section descriptions of the sections.

In step 405, in the UBI volume table, UBI system data is added to a header or each of the storage blocks corresponding to the section according to the section description file. The size of the sections is aligned with the size of the storage blocks. Each section may be aligned with one storage block or may be aligned with multiple storage blocks, depending on the sizes of the sections and the storages blocks. For example, assuming that the size of one section is 10240 KB and the size of one storage block is 1024 KB, the section is then aligned with 10 storage blocks.

After establishing the UBI volume table, the UBI system data is added to the header of each of the storage blocks corresponding to the section according to the section description file.

In step 406, the user data of the section is obtained. The user data is organized in an independent bin file in a form of divided sections. Each section has corresponding user data, and the user data corresponding to the section is obtained after performing step 405.

In step 407, it is determined whether the size of the user data is smaller than the size of the section corresponding to the section description file. That is, it is determined whether the size of the user data is smaller than the size of the section corresponding to the section description file.

Step 408 is performed when the size of the user data is smaller than the size of the section corresponding to the section description file, or else step 409 is performed when the size of the user data is not smaller than (greater than or equal to) the size of the section corresponding to the section description file.

In step 408, “0xFF” is added to the end of the user data. A purpose of this step is to ensure the alignment of the section and the storage block. The size of the sections is aligned with the size of the storage blocks when originally configured. However, unaligned sizes of the sections and the storage blocks may be incurred during the process of generating the burning file if the size of the user data is smaller than the size of the section. Thus, when it is determined that the size of the user data is smaller than the size of the section corresponding to the section description file in step 407, “0xFF” is added to the end of the user data so that the size of the user data added with “0xFF” is equal to the size of the section corresponding to the section description file.

In step 409, the user data is written into the corresponding storage block. The user data added with “0xFF” and having the size equal to that of the section corresponding to the section description file is written into the corresponding storage block.

In step 410, it is determined whether a last section has been processed. When the size of the user data equals the size of the section corresponding to the section description file, it is determined whether the last section has been processed. Step 411 is performed when the last section has not yet been processed, or else step 412 is performed when the last section has already been processed.

In step 411, a next set of section description information is obtained. When it is determined in step 409 that the last section has not yet been processed, the next set of section description information is obtained and step 402 is iterated.

In step 412, an ECC code is inserted into the preliminary burning file to generate a final burning file. That is, as a preliminary burning file is generated after processing the last section, the ECC code is further inserted into the preliminary burning file to generate the final burning file.

FIG. 6 shows a schematic diagram of constituents of a final burning file. The alignment filler “0xFF” in dotted lines is determined by the size of the user data and the size of the section. For example, the filler “0xFF” may be present or absent, i.e., the filler “0xFF” is optional depending actual requirements.

It should be noted that, the allocation information includes the number that the burning file is to be generated. That is, according to the number that the burning file is to be generated as instructed in the allocation information, one or multiple burning files may be generated. The number that the burning file is to be generated specified in the allocation information is designed according to actual requirements.

The allocation information may be implemented by a parameter. For example, when the parameter is 0, a single burning file is to be generated. Thus, the filler “0xFF” is to be considered at the end of the section to ensure that the sizes of the section and the storage block are aligned. Further, all user data needs to be written into a sole burning file.

For example, when the parameter is 1, independent files of individual sections need to be provided. For example, three burning files are generated assuming three MTD sections are present. The MTD sections are only inserted with the ECC code without the filler “0xFF” added to the end.

In a situation where different sections are required, a reserved section may be included. That is, certain sections may be defined with however no user data stored therein in an initial stage, and are reserved later for specific reasons. Thus, the allocation information associated with the reserved sections needs to be stored in the volume table of the entire area, while no corresponding user data is written into the burning file.

In this embodiment, by determining the file type, the burning file is generated from the user data according to the section description file and the number that the burning file is to be generated. Such an approach is simple, reliable, and flexible, and also increases burning efficiency.

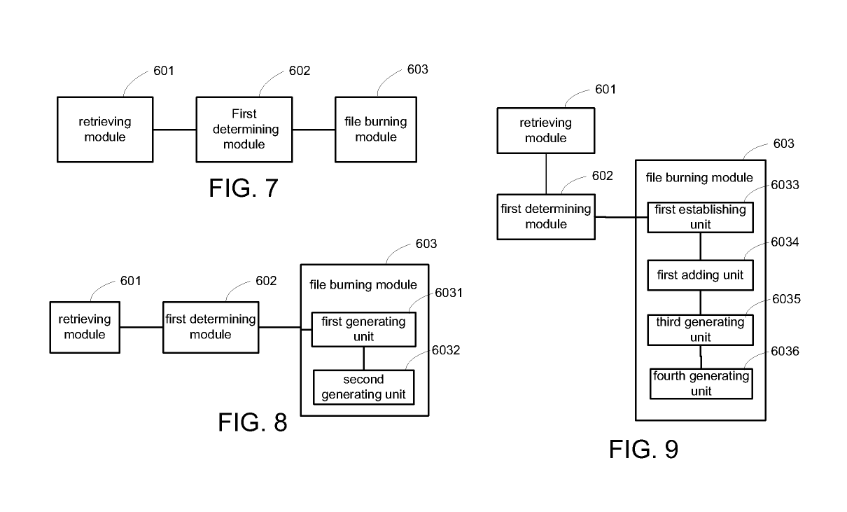

FIG. 7 shows a block diagram of a file programming device according to one embodiment. The file programming device according to one embodiment includes a retrieving module 601, a first determining module 602 and a file burning module 603. The modules may be flexibly and selectively implemented by software, hardware, or a combination of both.

The retrieving module 601 obtains a section description file and corresponding allocation information and user information when a burning file is to be generated for a NAND flash. The section description file includes section description information of one or multiple sections, and the allocation information includes the number that the burning file is to be generated.

The first determining module 602, electrically connected to the retrieving module 601, determines a file type of a section file corresponding to the section description file obtained by the retrieving module 601.

The file burning module 603, electrically connected to the first determining module 602, generates a burning file according to the section description information, the number of the burning file to be generated corresponding to the section description information, and the file type of the section file.

FIG. 8 shows a block diagram of a file programming device according to another embodiment. In this embodiment, the file burning module 603 includes a first generating unit 6031 and a second generating unit 6032 electrically connected to each other. The modules may be flexibly and selectively implemented by software, hardware, or a combination of both.

When the first determining module 602 determines that the section file corresponding to the section description file is an MTD type, the first generating unit 6031 writes the user data obtained by the retrieving module 601 into a corresponding storage block to generate a preliminary burning file. The number of the preliminary file is equal to the number of the burning file.

The second generating unit 6032 inserts an ECC code into the preliminary burning file generated by the first generating unit 6031 to generate a final burning file.

FIG. 9 shows a block diagram of a file programming device according to another embodiment. In this embodiment, the file burning module 603 includes a first establishing unit 6033, a first adding unit 6034, a third generating unit 6035 and a fourth generating unit 6036. The first establishing unit 6033 is electrically connected to the first adding unit 6034, and the third generating unit 6035 is electrically connected to the first adding unit 6034 and the fourth generating unit 6036.

When the first determining module 602 determines that the section file corresponding to the section description file is a UBI type, the first establishing unit 6033 establishes a UBI volume table including section descriptions of individual sections according to the section description information.

The first adding unit 6034 adds UBI system data to a header of each of the storage blocks corresponding to the sections according to section description information.

The third generating unit 6035 writes the user data into the corresponding storage block to generate a preliminary burning file. The number of the preliminary file is equal to the number of the burning file.

The fourth generating unit 6036 inserts an ECC code into the preliminary burning file generated by the third generating unit 6035 to accordingly generate a final burning file.

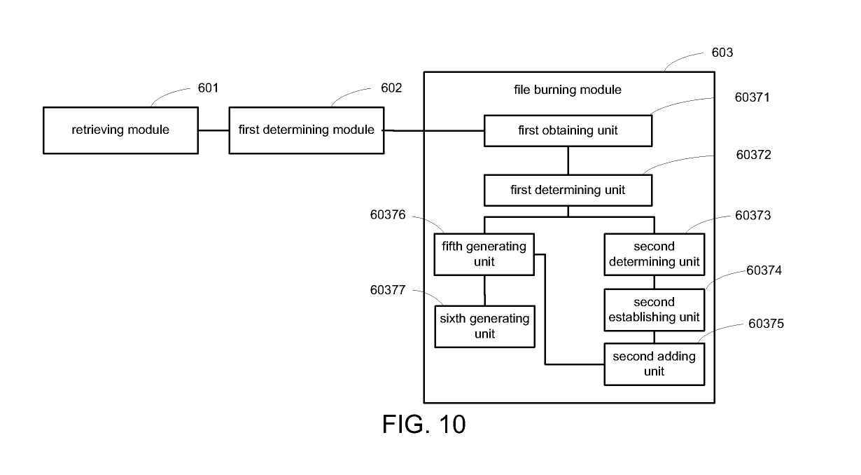

FIG. 10 shows a block diagram of a file programming device according to another embodiment. In this embodiment, the file burning module 603 includes a first obtaining unit 60371, a first determining unit 60372, a second determining unit 60373, a second establishing unit 60374, a second adding unit 60375, a fifth generating unit 60376, and a sixth generating unit 60377.

The first obtaining unit 60371 obtains a first set of section description information when the first determining module 602 determines that the section file corresponding to the section description file is a mixed type including MTD and UBI types.

The first determining unit 60372 determines whether a section corresponding to the section description file obtained by the first obtaining unit 60371 is the MTD type or the UBI type.

When the first determining unit 60372 determines that the section corresponding to the section description file is the UBI type, the second determining unit 60373 further determines whether the section description information is a first set of section description information of the UBI type.

When second determining unit 60373 determines that the section description information is a first set of section description information of the UBI type, the second establishing unit 60374 establishes a UBI volume table according to the section description information.

When second determining unit 60373 determines that the section description information is not a first set of section description information of the UBI type, the second adding unit 60375 adds UBI system data to a header of each of the storage blocks corresponding to the section according to the section description file.

When the first determining unit 60372 determines that the section corresponding to the section description information is the MTD type, the fifth generating unit 60376 writes the user data corresponding to the section to the corresponding storage block, and generates a preliminary burning file after having processed a last set of description information.

The sixth generating unit 60377 inserts an ECC code into the preliminary burning file generated by the fifth generating unit 60376 to generate a final burning file.

The file burning module 603 further includes a third determining unit and a filling unit (not shown). The third determining unit determines whether the size of the user data is smaller than the size of the section corresponding to the section description file. When the third determining unit determines that the size of the user data is smaller than size of the section corresponding to the section description file, the filling unit adds “0xFF” to the end of the user data so that the size of the user data equals the size of the section corresponding to the section description file.

Thus, a file programming device is provided as described in the embodiment. The file programming device is capable of determining a file type to generate a burning file utilizing user data with respect to different file types according to section description file and the number that the burning file is to be generated. Such an approach is simple, reliable, and flexible, and also increases burning efficiency.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A file programming method for a NAND flash, comprising:
obtaining a section description file, corresponding allocation information and user data when a burning file is required for the NAND flash, wherein the section description file comprises section description information of at least one section and the allocation information comprises a number that the burning file is to be generated;
determining a file type of a corresponding section according to the section description file; and
generating the burning file utilizing the user data according to the section description information, the number that the burning file is to be generated corresponding to the section description information, and the file type of the section file.

2. The file programming method according to claim 1, wherein the step of generating the burning file utilizing the user data according to the section description information, the number that the burning file is to be generated corresponding to the section description information, and the file type of the section file comprises:
when the file type of the section file is a Memory Technology Device (MTD) type, writing the user data into a corresponding storage block and generating a preliminary burning file; and
inserting an Error Checking and Correcting (ECC) code into the preliminary burning file to generate a final burning file.

3. The file programming method according to claim 2, further comprising:
determining whether a size of the user data is smaller than a size of a section corresponding to the section description file; and
when the size of the user data is smaller than the size of the section corresponding to the section description file, adding 0xFF to an end of the user data such that the size of the user data added with 0xFF equals the size of the section corresponding to the section description file.

4. The file programming method according to claim 1, wherein the step of generating the burning file utilizing the user data according to the section description information, the number that the burning file is to be generated corresponding to the section description information, and the file type of the section file, further comprises:
when the file type of the section file is an Unsorted Image Block (UBI) type, establishing a UBI volume table comprising section descriptions of individual sections according to the section description information;
adding UBI system data to a header to each of storage blocks corresponding to the section according to the section description information;
writing the user data into the corresponding storage block to generate a preliminary burning file; and
inserting an ECC code into the preliminary burning file to generate a final burning file.

5. The file programming method according to claim 4, before the step of writing the user data into the corresponding storage block to generate the preliminary burning file, further comprising:
determining whether a size of the user data is smaller than a size of a section corresponding to the section description file; and
when the size of the user data is smaller than the size of the section corresponding to the section description file, adding 0xFF to an end of the user data such that the size of the user data added with 0xFF equals the size of the section corresponding to the section description file.

6. The file programming method according to claim 1, wherein the step of generating the burning file utilizing the user data according to the section description information, the number that the burning file is to be generated corresponding to the section description information, and the file type of the section file, further comprises:
when the file type of the section file is a mixed type comprising an MTD type and a UBI type, obtaining a first set of section description information;
determining whether a section corresponding to the first set of section description is the MTD type or the UBI type;
when the section corresponding to the first set of section description is the MTD type, writing the user data corresponding to the section to a corresponding storage block until having processed a last set of section description information to generate a preliminary burning file; and
inserting an ECC code into the preliminary burning file to generate a final burning file.

7. The file programming method according to claim 6, further comprising:
when the section corresponding to the first set of section description is the UBI type, determining whether the section description information is a first set of section description information of the UBI type;
when the section description information is not the first set of section description information of the UBI type, adding UBI system data to a header of each of storage blocks corresponding to the section according to the section description file, and writing the user data corresponding to the section to the corresponding storage until having processed the last set of section description information to generate the preliminary burning file; and
inserting the ECC code into the preliminary burning file to generate the final burning file.

8. The file programming method according to claim 6, further comprising:
determining whether a size of the user data is smaller than a size of a section corresponding to the section description file; and
when the size of the user data is smaller than the size of the section corresponding to the section description file, adding 0xFF to an end of the user data such that the size of the user data added with 0xFF equals the size of the section corresponding to the section description file.

9. The file programming method according to claim 8, further comprising:
when the section description information is the first set of section description information of the UBI type, establishing a UBI volume table according to the section description information; and
performing the step of adding the UBI system data to the header of each of the storage blocks corresponding to the section according to the section description file.

10. A file programming device for a NAND flash, comprising:
a retrieving module, for retrieving a section description file and corresponding allocation information and user data when a burning file is required for the NAND flash, wherein the section description file comprises section description information of at least one section and the allocation information comprises a number that the burning file is to be generated;
a first determining module, for determining a file type of a corresponding section according to the section description file obtained by the retrieving module; and
a file burning module, for generating the burning file utilizing the user data according to the section description information, the number that the burning file is to be generated corresponding to the section description information, and the file type of the section file.

11. The file programming device according to claim 10, wherein the file burning module comprises:
a first generating unit, for writing the user data into a corresponding storage block to generate a preliminary burning file when the first determining module determines that a section corresponding to the section description file is an MTD type; and
a second generating unit, for inserting an ECC code into the preliminary burning file generated by the first generating unit to generate a final burning file.

12. The file programming device according to claim 10, wherein the file burning module comprises:
a first establishing unit, when the first determining module determines that the section is the UBI type, for establishing a UBI volume table comprising section descriptions of individual sections according to the section description information;
a first adding unit, for adding UBI system data to a header of each of storage blocks corresponding to the section according to section description information;
a third generating unit, for writing the user data into the corresponding storage block to generate a preliminary burning file; and
a fourth generating unit, for inserting an ECC code into the preliminary burning file generated by the third generating unit to generate a final burning file.

13. The file programming device according to claim 10, wherein the file burning module comprises:
a first obtaining module, for obtaining a first set of section description information when the first determining module determines that the section is a mixed type comprising the MTD type and the UBI type;
a first determining unit, for determining whether a section corresponding to the first set of section description information is the MTD type or the UBI type;
a fifth generating unit, when the first determining unit determines that the section corresponding to the section description information is the MTD type, for writing the user data into a corresponding storage block until having processed a last set of section description information to generate a preliminary burning file; and
a sixth generating unit, for inserting an ECC code into the preliminary burning file generated by the fifth generating unit to generate a final burning file.

14. The file programming device according to claim 13, wherein the file burning module further comprises:
a second determining unit, when the first determining unit determines that the section corresponding to the section description information is the UBI type, for determining whether the section description information is a first set of section description information of the UBI type;
a second establishing unit, when the second determining unit determines that the section description information is the first set of section description information of the UBI type, establishing a UBI volume table according to the section description information; and
a second adding unit, when the second determining unit determines that the section is not the first set of section description information of the UBI type, for adding UBI system data to a header of each of storage blocks corresponding to the section according to the section description file.

15. The file programming device according to claim 11, wherein the file burning module further comprises:
a third determining unit, for determining whether a size of the user data is smaller than a size of a section corresponding to the section description file; and
a filling unit, when the third determining unit determines that the size of the user data is smaller than the size of the section corresponding to the section description file, for adding 0xFF to an end of the user data such that the size of the user data added with 0xFF equals the size of the section corresponding to the section description file.

16. The file programming device according to claim 12, wherein the file burning module further comprises:
a third determining unit, for determining whether a size of the user data is smaller than a size of a section corresponding to the section description file; and
a filling unit, when the third determining unit determines that the size of the user data is smaller than the size of the section corresponding to the section description file, for adding 0xFF to an end of the user data such that the size of the user data added with 0xFF equals the size of the section corresponding to the section description file.

17. The file programming device according to claim 14, wherein the file burning module further comprises:
a third determining unit, for determining whether a size of the user data is smaller than a size of a section corresponding to the section description file; and
a filling unit, when the third determining unit determines that the size of the user data is smaller than the size of the section corresponding to the section description file, for adding 0xFF to an end of the user data such that the size of the user data added with 0xFF equals the size of the section corresponding to the section description file.
